(19) United States
(12) Patent Application Publication
(10) Pub. No.: US 2009/0076864 A1
(43) Pub. Date: Mar. 19, 2009

(54) SYSTEM AND METHOD FOR RULES-BASED SERIALIZED SERVICE TRANSACTION PROCESSING

(75) Inventors: Alfred KAHN, IV, Denver, CO (US); David S. JOHNSON, Denver, CO (US)

Correspondence Address: SoCAL IP LAW GROUP LLP, 310 N. WESTLAKE BLVD. STE 120, WESTLAKE VILLAGE, CA, 91362, US

(73) Assignee: IP COMMERCE, INC., Denver, CO (US)

(21) Appl. No.: 11/855,799

(22) Filed: Sep. 14, 2007

(51) Int. Cl. G06Q 10/00

(52) U.S. Cl. 705/7; 705/1

(57) ABSTRACT

The present invention is directed to a services system using Internet Protocol (“IP”), integrating applications, and enabling participants of the services system to collaborate, and build, provision, and manage payment (commerce) services. The services network enables multiple transactions contained within a single transaction message to be processed by multiple participants within in the service system. Commerce business rules govern how individual transactions with a multi-transaction message are processed by participants in the service system.

### BACKGROUND OF THE INVENTION

1. Field of the Invention

The present invention relates to a system and method for managing the processing of multi-transaction messages, and more particularly, to a system and method for managing the processing of multi-transaction messages by multiple participants within a services system or network, wherein the processing is governed by one or more commerce business rules.

2. Discussion of the Related Art

Today's computing systems and computer networks are processing an ever increasing number of transactions to accomplish their specified computing requirements. For example, one or more nodes within a distributed computer network may be required to handle transaction requests from a wide variety of services from within the computer network. Many transactions may be interrelated and may even depend upon one another for further processing. Waiting for the notification that a transaction has completed processing and for data to be returned so that a subsequent transaction may be requested creates delays and inefficiencies for any computing system.

For example, within a computer network, such as a payment network, a complete transaction may include a number of individual commerce transactions. Each of these commerce transactions is typically processed separately. The commerce transactions must also be monitored by a requesting process to determine what consequences the end result of that transaction may have on any subsequent transaction or what sequence of actions is to take place next to reach the end result of a multi-transaction process. Retrieving, re-analyzing, and resending each transaction adds to the total processing time and overhead of each transaction. Furthermore, many steps may include repetitive processing steps that further decrease the efficiency of the overall processing of the multi-transaction processing.

These and other deficiencies exist in computing networks as described above as well as in smaller scale computing networks used in processing interrelated commerce transactions. Therefore, a solution to these and other problems is needed to provide a multi-transaction processing mechanism for managing the processing of multi-transaction requests with an established set of commerce business rules.

### SUMMARY OF THE INVENTION

Accordingly, the present invention is directed to a system and method for managing the processing of multi-transaction messages with a set of commerce business rules.

The computing system of the present invention, according to one embodiment, is a networked computing system with access to transaction processors for processing one or more transactions according to a set of commerce business rules and includes a multi-transaction processor for managing the processing of one or more transactions from a multi-transaction message against the commerce business rules. The commerce business rules are maintained in a database accessible by the transaction processors and the multi-transaction processor managing the processing of the multi-transaction message.

According to one embodiment of the present invention, a computing system provides a least one database containing commerce business rules and at least one processing unit, such as a server, operable to execute a multi-transaction process for receiving a multi-transaction request, creating a multi-transaction message, and controlling the analysis and processing the transactions of the multi-transaction message against the commerce business rules.

According to further embodiments, the commerce business rules of the present invention contain attributes for classifying transactions for processing based either solely on the data within a transaction, or upon the combination of the data of a transaction as well as data resulting from the processing of one or more additional transactions from within the multi-transaction message.

In a further embodiment, commerce business rules contain attributes for instructing the computer system to process individual transactions within the multi-transaction message based on the attributes returned from the processing of transactions contained in previous sections of the multi-transaction message.

In a further embodiment, individual transactions within a multi-transaction message are processed serially according to their position within the multi-transaction message.

It is to be understood that both the foregoing general description and the detailed description provided below are exemplary and explanatory and are intended to provide further explanation of the invention as claimed but not to narrow the invention.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 shows a system view of a computer network, according to an embodiment of the present invention;

FIG. 2A shows an example of the processing of a multi-transaction message, according to an embodiment of the present invention;

FIG. 2B shows an example of the processing of a multi-transaction message that is not fully processed, according to an embodiment of the present invention; and

FIG. 3 is a flow diagram showing a method for managing the processing of multiple transactions from a multi-transaction message, according to an embodiment of the present invention.

### DETAILED DESCRIPTION OF VARIOUS EMBODIMENTS

Reference will now be made in detail to various embodiments of the present invention, examples of which are illustrated in the accompanying drawings.

In general, the present invention is directed to a system and method for managing the processing of a multi-transaction message according to a set of commerce business rules. It will be clear to one skilled in the art that the present invention is applicable to any computing system capable of processing commerce transactions from a multi-transaction message, whether a simple computer processing system or a complex distributed network, such as a payment services network.

While the present invention is equally applicable to small, medium, or large computing systems, for ease of explanation, the following description uses a payment services network. The example payment services network provides a federated set of Internet Protocol (“IP”) payments platform instances peered with one another communicating through IP. The payment services network provides an expanded network providing a wide variety of services and capabilities to a wide range of users. Many of these services may be interrelated and depend on one another.

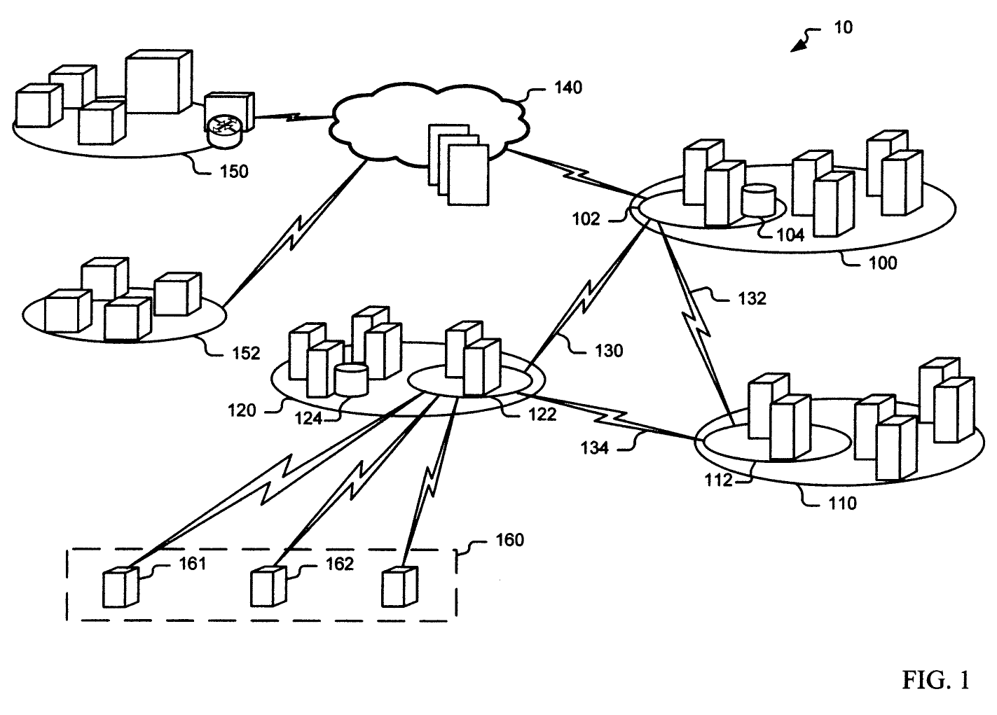

FIG. 1 shows a system view of a distributed computer network, according to an embodiment of the present invention. The distributed computer network 10 will be described in terms of a payment service network. For example, the payment services network, as shown in FIG. 1, includes a number of IP payment platforms 102, 112, and 122 within various participant networks 100, 110, and 120. Participant networks may include banks, payment processors, or retailers, for example. The IP payment platforms 102, 112, and 122 are peered with one another via peer interconnections 130, 132, and 144 to form a service grid.

Each IP payment platform 102, 112, or 122 is a managed service set providing various core capabilities, such as organization management, business rules, service agreements, transaction routing and management, service bundles, order management, operations controls, reporting, rating, an application programming interface, data capture, and merchant storefronts.

The IP payment platforms 102, 112, or 122, as shown in FIG. 1, provide retailers 150, providers of business productivity software 152, Independent Software Vendors (“ISV”) and third-party service providers 160, and others the ability to be incorporated into the payment services network directly through an IP payment platform or via the Internet 140.

According to an embodiment of the present invention, commerce business rules are created and stored in a commerce business rules database, such as data store 104 within IP payment platform 102 or data store 124 within participant network 120. In further embodiments, the commerce business rules database may be placed anywhere accessible by a processor or server processing a particular multi-transaction message. It will be clear to one skilled in the art that a commerce business rules database may be stored in one location or distributed across a network or networks as is necessary for data security and efficiency.

In one embodiment, commerce business rules are created by selecting one or more commerce business rule attributes and establishing values to those selected attributes. Commerce business rules provide all participants of network 10 with common standards for operating within the network 10. According to the embodiment shown in FIG. 1, commerce business rules may be formulated through partner service agreements, peering alliances, as well as participant defined process requirements and exemptions, for example. In further embodiments, commerce business rules may be formulated or created in any manner consistent with the requirements of the multi-transaction processing system.

An embodiment of the present invention provides a computer system, such as that described in FIG. 1, containing a multi-transaction processor providing the ability for a customer to submit a single request containing multiple transactions to the network for a variety of services. The multi-transaction processor manages the processing of the multiple transactions by validating the transactions as a whole and individually, forwarding each transaction to the appropriate transaction processor, and maintaining processed transaction data returned from each transaction processor upon completion of each transaction.

For example, a bank within the network 10 may have a customer seeking financing for a home or other item. For the bank to process such a request, multiple transactions such as risk management services, credit history reporting, employment reporting, loan rate calculations, and loan approval, to name only a few, must be processed before a loan is provided to the customer. According to one embodiment, these transactions would be grouped into a single request, forwarded to the multi-transaction processor where the set of transactions would be validated and directed to the appropriate location for processing. Upon completion of the processing of each transaction, the transaction data returned to the multi-transaction processor would be bundled into a response and returned to the bank.

In operation, according to an embodiment of the present invention, a multi-transaction request is provided to a multi-transaction processor, such as a server within the computer system 10. For example, a server 161 within the set of third-party service providers 160 or any other server accessible within computer system 10 may provide multi-transaction processing. The multi-transaction request is then analyzed against a set of commerce business rules to determine if the request is valid.

Accordingly, after the request is determined to be valid, each transaction is removed from the request to form a multi-transaction message and each transaction is analyzed in turn against the commerce business rules. If a transaction is determined to be valid it is forwarded to the appropriate processor or processing system for processing the transaction data for that process. Upon completion of processing the transaction data, processed transaction data is returned and the transaction is identified as processed. As with the multi-transaction processor, the transaction processor could be any server within computer system 10, such as server 162 within the set of third-party service providers 160 or any other server accessible within computer system 10.

According to an embodiment of the present invention, if, while processing the multi-transaction message, a transaction is determined to be invalid, processing of the multi-transaction message is terminated and all remaining transactions are marked as not processed.

According to one embodiment of the present invention, processed transaction data from each individual transaction may be stored with that processed transaction. Some or all of the processed transaction data may be accessible to subsequent transactions as they are analyzed and/or processed against the commerce business rules.

According to one embodiment of the present invention, commerce business rules contain attributes for enabling the computer system of the present invention to classify transactions for processing based solely on the data within a particular transaction. In a further embodiment, commerce business rules contain attributes for enabling the computer system of the present invention to classify transactions for processing based on the combination of the data of a transaction and processed transaction data resulting from the processing of one or more other transactions from within the multi-transaction message.

In a further embodiment, individual transactions from within a multi-transaction message may be processed based on the result of previous processing of one or more other transactions from within the same multi-transaction message. According to such an embodiment, commerce business rules are defined to contain attributes that instruct the computing system to process individual transactions within the multi-transaction message based on the attributes returned from the processing of transactions contained in previous sections of the message.

In a further embodiment, individual transactions within a multi-transaction message are processed serially in sequence of order within the multi-transaction message based on the commerce business rules. According to such an embodiment, the computing system evaluates the characteristics of the multi-transaction message in accordance with one of the methods described above to determine whether or not to continue processing subsequent transactions within the multi-transaction message based on commerce business rule attributes associated with the characteristics of the transaction or the result of processing the previous transaction within the multi-transaction message.

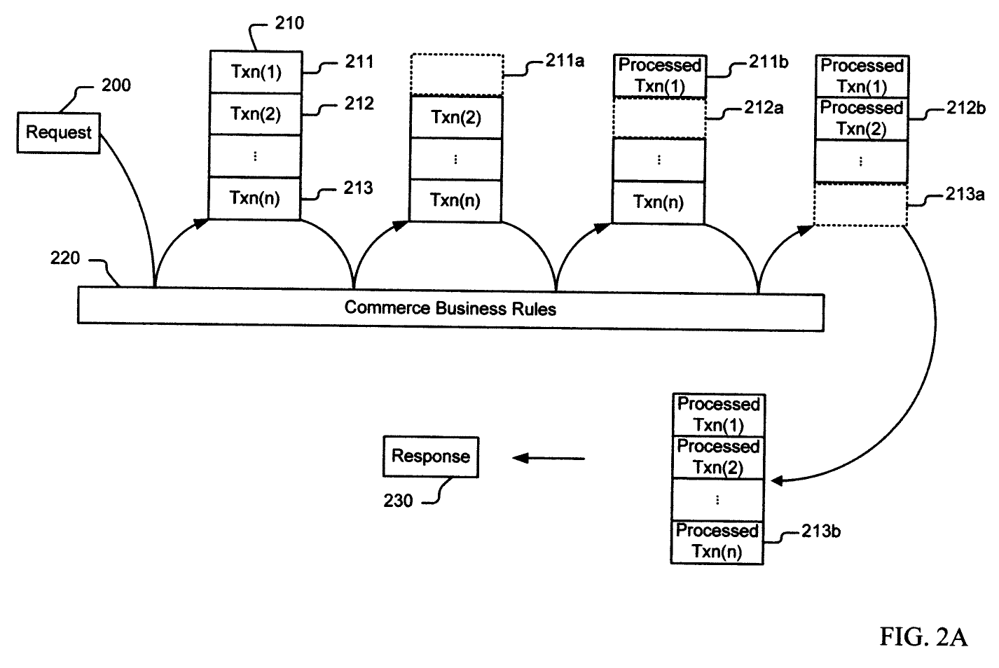

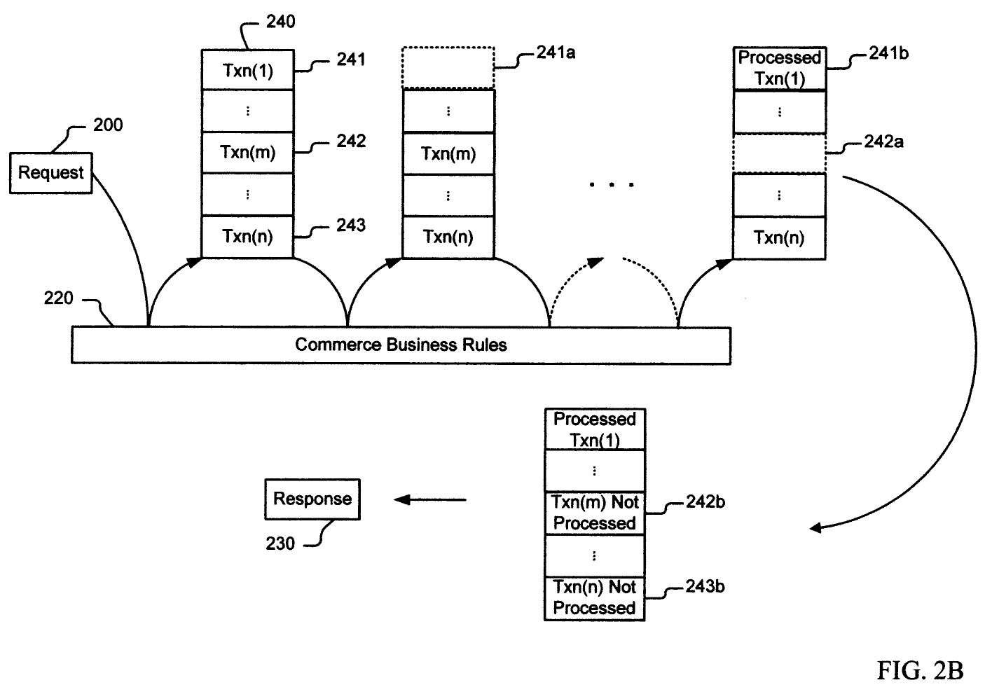

FIG. 2A shows an example of the processing of a multi-transaction message, according to an embodiment of the present invention. In FIG. 2A, processing begins when a request 200 is received. Request 200 includes one or more transactions. request 200 may also include meta-data associated with the request 200 and included transactions. The meta-data provides the transaction information and the specified service requested for each transaction.

Request 200 is initially analyzed against commerce business rules 220 to determine whether or not the request as a whole includes valid transactions and information that can be processed with the commerce business rules 220. If request 200 is determined to be valid and capable of being processed with commerce business rules 220, each transaction is removed from the request 200 to form a multi-transaction message 210. If the request is unable to be processed, a response (not shown) is generated indicating that the request is invalid and the response is returned.

The multi-transaction message 210 generated from request 200, as shown in the example in FIG. 2A, includes n-transaction messages 211, 212, and 213. According to various embodiments of the present invention, multi-transaction message 210 may contain one or more transaction messages. According to a further embodiment, multi-transaction message 210 will also include meta-data for the complete set of transactions. Where more than one transaction is included in a multi-transaction message, each individual transaction is contained within an individual transaction section associated with one and only one service.

In a further embodiment, each individual transaction section will also contain meta-data specific to the transaction within that section. According to various embodiments of the present invention, transaction specific meta-data may include basic meta data, meta-data specific to the framework or computing system on which the transactions are processed, and/or contextual information used for describing the response for the processed transaction, as well as assisting in further processing of the transaction or subsequent transactions.

In a further embodiment, each transaction is located in sequence specific to the order in which the transactions should be processed. For example, in one embodiment, the transactions may be physically organized in a specific order within the multi-transaction message. In a further embodiment, each transaction may include a pointer to the succeeding transaction. In a further embodiment, each transaction may include a pointer to the succeeding and proceeding transactions.

Returning to FIG. 2A, the multi-transaction message 210 is initially evaluated against commerce business rules 220 to determine the validity of and necessary processing for the first transaction 211. If the first transaction 211 is determined to be valid, it is forwarded to the appropriate transaction processor and processed according to the commerce business rules identified for that particular transaction, shown at 211a. After successfully processing the first transaction 211, the first transaction 211 and any processed transaction data returned as part of the transaction processing is marked as a processed transaction 211b.

After processing is completed for the first transaction 211, multi-transaction message 210 is then evaluated against commerce business rules 220 to determine the proper processing for the second transaction 212. In one embodiment, the evaluation of the subsequent transaction may also include an analysis of any transaction data returned from the processing of the first transaction. If transaction 212 is determined to be valid it is then forwarded to the appropriate transaction processor and processed, shown at 212a, according to the commerce business rules 220 identified for that particular transaction. After processing is complete for transaction 212, transaction 212 and any processed transaction data returned as part of the transaction processing is identified as a processed transaction 212b.

According to the example shown in FIG. 2A, processing of multi-transaction message 210 continues in the same manner through the nth transaction 213 where the multi-transaction message is evaluated against commerce business rules 220 to determine the proper processing for the nth transaction 213. In further embodiments, the evaluation of the subsequent transaction may also include an analysis of any transaction data returned from the immediately preceding transaction or transaction data from all preceding transactions. The nth transaction 213 is then forwarded to the appropriate processing system and processed, shown at 213a, according to the commerce business rules identified for that particular transaction. After processing is complete, the nth transaction and its associated processed transaction data is identified as processed 213b.

After all n transactions are processed, a response 230 is generated based on the processed transactions 211b, 212b, and 213b of the multi-transaction message and any processed transaction data, and the response 230 is returned to the requesting entity.

FIG. 2B shows an example of the processing of a multi-transaction message that is not fully processed, according to an embodiment of the present invention. Similar to the example shown in FIG. 2A, processing begins in FIG. 2B when a request 200 is received. Request 200 of FIG. 2B also includes one or more transactions and meta-data associated with the request 200. Request 200 is analyzed with commerce business rules 220 to determine whether or not the request as a whole includes valid transactions and information that can be processed with the commerce business rules 220. If request 200 is valid, the transactions are removed from the request to form a multi-transaction message 240.

Multi-transaction message 240, as shown in FIG. 2B, includes n transactions 241, 242, and 243. According to various embodiments of the present invention, multi-transaction message 240 may contain one or more transactions.

Multi-transaction message 240 is initially evaluated against commerce business rules 220 to determine the validity and necessary processing for the first transaction 241. If the first transaction 241 is valid it is forwarded to an appropriate transaction processor and processed according to the commerce business rules identified for that particular transaction, shown at 241a. After the first transaction 241 is processed, processed transaction data is returned and the transaction is marked as a processed transaction 241b.

After the first transaction 241a is processed, multi-transaction message 240 is then evaluated against commerce business rules 220 to determine the proper processing for the next transaction, if any. According to the example shown in FIG. 2B processing continues in a similar fashion until reaching the m-th transaction 242. As the m-th transaction message 242 is processed, shown at 242a, it is determined, according to commerce business rules 220, that processing should not be completed. According to various embodiments, such a determination may be based on information collected during the processing of the transaction, on processed transaction data collected during the processing of previous transactions within the multi-transaction message 240, or that the transaction is not a valid process, for example.

After it is determined that a transaction should not be processed the transaction is flagged as “not processed” 242b. According to the embodiment shown in FIG. 2B, any remaining transactions through the n-th transaction 243b are also flagged as “not processed.” Response 230 is then generated based on any processed transaction data returned from any of the processed transactions, the “not processed” transactions are identified as such, and the response 230 is returned to the requesting entity.

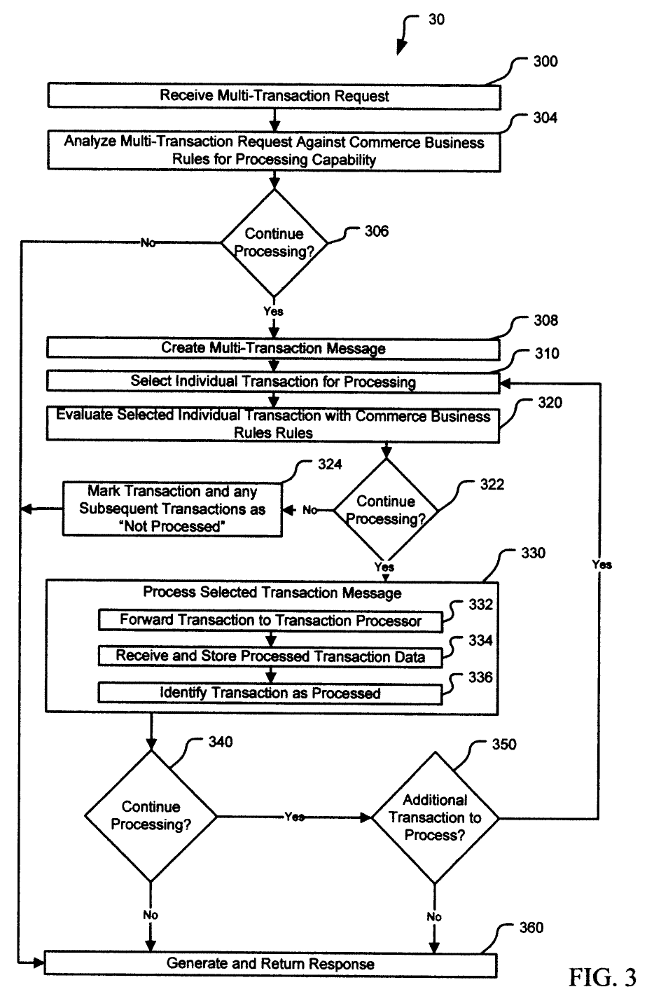

FIG. 3 provides a flow diagram showing a method for managing the processing of multiple transactions from a multi-transaction message, according to an embodiment of the present invention. The method begins at step 300 with the receipt of a multi-transaction request. At step 304, the request is analyzed against commerce business rules to determine whether the request is valid and able to be processed against the commerce business rules. If the request is invalid, processing is terminated at step 306 and the process moves to step 360 where a response indicating the invalidity of the request is generated and returned.

If the request is determined to be valid, the process continues to step 308 where the individual transactions from within the request are extracted and a multi-transaction message is generated. At step 310 an individual transaction is selected for processing. According to one embodiment, the selection of the individual transaction to be processed is determined by the order in which the transactions are ordered within the multi-transaction message, such as the physical order or following a pointer from one transaction to another, for example.

At step 320, the selected transaction is evaluated against commerce business rules to determine the appropriate processing for the selected transaction. If the selected transaction is invalid or otherwise unable to be processed according to the commerce business rules, processing is terminated at step 322 and the process moves to step 324 where the transaction and an subsequent transactions are marked as “not processed” and step 360 where a response is generated and returned. If the process is valid and able to be processed according to the commerce business rules, the process moves from step 322 to step 330 for processing of the transaction.

At processing step 330, the transaction is forwarded for processing according to the commerce business rules, step 332. In one embodiment, the transaction is processed based on the data within the transaction being processed. In a further embodiment, the transaction is processed based on a combination of the data within the transaction being processed and data resulting from the processing of another transaction. In a further embodiment, a transaction is processed based on attributes returned from the processing of transactions contained in previous sections of the multi-transaction message.

Upon completion of the processing the transaction, processed transaction data is received and stored at step 334. According to various embodiments of the present invention, processed transaction data may be data generated during the processing of the transaction or simply a response that the transaction has completed processing. Once the processed transaction data is received, the transaction is identified as a processed transaction at step 336.

Once processing for a transaction message is complete, the process moves to step 340 to determine whether or not to continue processing subsequent transactions within the multi-transaction message. This determination may be made based, according to one embodiment, on processing rule attributes associated with the characteristics of the transaction. In a further embodiment, it may be based on attributes associated with the result of processing the previous transaction, such as whether or not the transaction was processed or not processed.

If processing is to continue, the process moves to step 350 to determine whether or not additional transactions are available for processing. If additional transactions are available for processing the method returns to step 310. If processing is complete and there are no more transactions to be processed the process moves to step 360 where a response is generated based on the processed multi-transaction message and the response is returned.

It will be apparent to one skilled in the art that various modifications and variations can be made in the present invention without departing from the spirit or scope of the invention. Thus, it is intended that the present invention cover the modifications and variations of this invention provided that they come within the scope of any claims and their equivalents.

What is claimed is:

1. A system for managing the processing of a multi-transaction request, comprising:
at least one database containing commerce business rules;
at least one server operable to execute a multi-transaction management process for receiving a multi-transaction request, creating a multi-transaction message, and managing the analysis and processing of the multi-transaction message according to the commerce business rules.

2. The system of claim 1, wherein the multi-transaction message further comprises;
a set of one or more transactions; and
meta-data associated with the set of one or more transactions.

3. The system of claim 1, wherein the multi-transaction message further comprises a set of one or more transactions and each transaction within the set of a one or more transactions is contained within a distinct section of the multi-transaction message and each distinct section is associated with one service.

4. The system of claim 3, wherein each distinct section within the transaction message associated with a service, contains meta-data specific to the transaction within that section.

5. The system of claim 4, wherein each distinct section of the multi-transaction message is in a sequence specific order in which the transactions are to be processed.

6. A method for processing a multi-transaction message based on the characteristics of one or more individual transactions within the multi-transaction message, comprising the steps of:
receiving a request for processing a multi-transaction message, the request containing one or more individual transactions;
analyzing the request against commerce business rules to determine if the one or more individual transactions are valid for processing with the commerce business rules;
in the event that the one or more individual transactions are valid for processing, creating a multi-transaction message by removing each of the one or more transactions from the request to form a multi-transaction message containing each of the one or more transactions;
analyzing a first transaction from the one or more transactions against the commerce business rules to determine if the transaction is valid for processing with the commerce business rules; and
in the event that the first transaction is valid for processing, processing the first transaction against the commerce business rules.

7. The method of claim 6, further comprising the steps of:
analyzing a second transaction from the one or more transactions against the commerce business rules to determine if the transaction is valid for processing with the commerce business rules; and
in the event that the second transaction is valid for processing, processing the second transaction against the commerce business rules.

8. The method of claim 6, further comprising the step of:
processing the remaining transactions from the one or more transactions;
creating a response message with processing results from each of the one or more transactions;
forwarding the response message.

9. The method of claim 6, further comprising the step of defining commerce business rules to contain attributes enabling a services system to classify transactions for processing based on data within a transaction.

10. The method of claim 6, further comprising the step of defining commerce business rules to contain attributes enabling a services system to classify transactions for processing based upon the combination of data of a first transaction and data resulting from the processing of a second transaction.

11. The method of claim 6, wherein the transactions within a multi-transaction message are processed serially in sequence of order within the multi-transaction message.

12. The method of claim 6, further comprising the step of evaluating the characteristics of the multi-transaction message to determine whether or not to continue processing subsequent transactions within the multi-transaction message based on processing rule attributes associated with the characteristics of the transaction.

13. The method of claim 6, further comprising the step of evaluating the characteristics of the multi-transaction message to determine whether or not to continue processing subsequent transactions within the multi-transaction message based on the result of processing the previous transaction within the message.
